(19) United States
(12) Patent Application Publication
(10) Pub. No.: US 2017/0322186 A1
(43) Pub. Date: Nov. 9, 2017

(54) Processing Apparatus

(71) Applicant: FACTORY AUTOMATION TECHNOLOGY CO., LTD., Chiayi County (TW)

(72) Inventors: PO CHENG SU, Chiayi County (TW); Hsin Hong Hou, Chiayi County (TW); Fan Tien Cheng, Chiayi County (TW); Haw Ching Yang, Chiayi County (TW); Hao Tieng, Chiayi County (TW)

(21) Appl. No.: 15/587,360

(22) Filed: May 4, 2017

(30) Foreign Application Priority Data
May 4, 2016 (TW) 105206396

(51) Int. Cl. G01N 29/44; G06N 5/04; G01N 27/00; G06N 99/00; G01N 21/88

(52) U.S. Cl. CPC G01N 29/44; G06N 99/005; G01N 21/88; G01N 27/00; G06N 5/04

(57) ABSTRACT

A processing apparatus includes a processing quality prediction unit capable of outputting workpiece surface processing signal, a storage unit capable of storing workpiece surface processing signal, and a workpiece surface information management unit capable of interpreting workpiece surface processing signal. The workpiece surface information management unit can convert the surface processing signal into data of workpiece surface quality. The workpiece surface information management unit can be utilized to respectively interpret the surface processing signals provided by the processing quality prediction unit and to convert them into data of the roughness degree of the workpiece surface texture, so as to clearly provide information regarding the quality of the workpiece surface and completely utilize the signals detected during the processing for increasing the value added of the processing apparatus and enhancing the efficiency of use of the processing apparatus.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to a processing apparatus, and more particularly to a processing apparatus that sorts and organizes the surface processing signals collected during the processing.

### Description of Related Arts

In order to upgrade the efficiency and quality of workpiece processing, the industry utilizes numerical controlled digital processing apparatus to process the processing machine and applies relatively new workpiece processing quality prediction technology to expect that the workpiece processing quality can be timely and effectively managed during the processing. This workpiece processing quality prediction technology is disclosed in Taiwan Patent Number TWI481978B, entitled “Method for predicting machining quality of machine tool” (claiming priority of U.S. patent application Ser. No. 61/722,250). It can predict data of the quality of the processed workpiece during the processing of the workpiece. Unfortunately, there has not been classification/organization use or analytic application of such prediction data of quality. For instance, the output electrical signal or vibration signal can not further be converted into data for, say, showing the roughness of the processed surface, so as for the reference and further understanding of the quality of the surface texture of the processed workpiece of the time. Hence, if the output signal can be further utilized, it will be able to further enhance the effectiveness of the resource utilization.

### SUMMARY OF THE PRESENT INVENTION

Therefore, an object of the present invention is to provide a processing apparatus that can fully utilize the processing information on the surface of the workpiece.

Accordingly, the processing apparatus according to the present invention comprises a processing quality prediction unit capable of outputting workpiece surface processing signal a storage unit capable of storing workpiece surface processing signal, and a workpiece surface information management unit capable of interpreting workpiece surface processing signal. The workpiece surface information management unit can convert the surface processing signal into data of workpiece surface quality. The workpiece surface information management unit can be utilized to respectively interpret the surface processing signals provided by the processing quality prediction unit and to convert them into data of the roughness degree of the workpiece surface texture, so as to clearly provide information regarding the quality of the workpiece surface and completely utilize the signals detected during the processing for increasing the value added of the processing apparatus and enhancing the efficiency of use of the processing apparatus.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a block diagram illustrating a processing apparatus according to the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

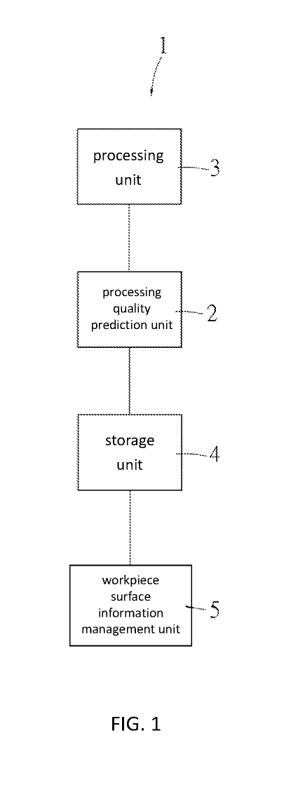

Referring to FIG. 1, the processing apparatus according to a preferred embodiment of the present invention is for processing a workpiece and organizing the workpiece surface processing information output during the processing, so as for the processor's or buyer's reference. The processing apparatus 1 comprises a processing quality prediction unit 2, a processing unit 3, a storage unit 4, and a workpiece surface information management unit 5. The processing quality prediction unit 2 is connected with both the processing unit 3 and the storage unit 4 electronically. The workpiece surface information management unit 5 is connected with the storage unit 4 electronically.

The processing quality prediction unit 2 utilizes the technology disclosed in Taiwan Patent Number TWI481978B, entitled “Method for predicting machining quality of machine tool.” It mainly applies Computer-Aided dDsign (CAD) to produce the outline, dimensions, and tolerance of the workpiece and uses Computer Aided Manufacturing (CAM) to generate processing path on the above dimensions and tolerance as well as the characteristics of the processing unit 3. Also, at least a product accuracy category has to be assigned. The product accuracy category comprises roughness and/or dimension deviation, and etc. The dimension deviation comprises straightness, angularity, perpendicularity, parallelism, and/or roundness, etc. The product accuracy category is associated with the processing path so as to provide a plurality of relevancies between the product accuracy category and the processing path. Then, the processing unit 3 will be utilized to process multiple workpieces according to the processing path to produce workpiece samples and to collect multiple sets of sample detection information of the multiple workpiece samples that relate to the processing path during the processing period. After the operation of sampling, it utilizes algorithm to control the noise of the detection information and convert the detection information of workpiece sample into sample characteristic data in correspondence with characteristic format. After the processing of workpiece sample is finished, the metrology machine is utilized to measure the product accuracy category(ies) of the workpiece sample so as to obtain a set of quality sample data (value of accuracy). Then the quality sample data and the characteristic data of the workpiece sample are utilized to predict the interrelation between the algorithm and processing path and the product accuracy category, in order to build a prediction model for the product accuracy category. That is to say, the characteristic data, quality sample data, and accuracy of workpiece, which are obtained when the processing unit 3 processed the workpiece sample, are utilized to form a prediction model.

In short, the processing quality prediction unit 2 generates a workpiece processing path for the target workpiece according to the predetermined dimensions, tolerance, and parameters and virtually predicts the processing quality of the workpiece and outputs accurate data of workpiece surface quality. The data of workpiece surface quality may comprise electrical signal, workpiece processing vibration signal, and workpiece surface image signal. In the case of electrical signal, if the electrical signal turns stronger instantly, it indicates poor smoothness of the processing, which could be rendered by factors like blunt tool, improper depth of cut, etc. that can all increase roughness of the workpiece surface. On the contrary, if the electrical signal is within a certain value range, it means that the processing is smooth and the processing quality of the workpiece surface meets the requirements. Similarly, both strength of the vibration signal and workpiece surface image signal can also be converted into data of workpiece surface processing quality.

The storage unit 4 is for storing all kinds of data of workpiece surface quality output by the processing quality prediction unit 2. In the present embodiment, the storage unit 4 can be a cloud storage device to establish big data for the processing signal.

The workpiece surface information management unit 5 is to interpret and determine whether each signal in the storage unit 4 meets the processing surface quality requirements and to respectively convert the electrical signal, workpiece processing vibration signal, or workpiece surface image signal output by the processing quality prediction unit 2 into data of workpiece surface processing quality. The data include the information regarding roughness of the workpiece surface processing texture, which indicates the surface condition of the processed workpiece. In the present embodiment, the workpiece surface information management unit 5 utilizes programmed artificial intelligence device to interpret each signal from the storage unit 4, so as to rapidly and precisely reveal the data of workpiece surface processing quality for the designer or buyer to refer to.

The processing apparatus according to the present invention utilizes the workpiece surface information management unit 5 to respectively interpret the surface processing signals provided by the processing quality prediction unit 2 and to convert them into data of the roughness degree of the workpiece surface texture, so as to clearly provide information regarding the quality of the workpiece surface and completely utilize the signals detected during the processing for increasing the value added of the processing apparatus 1 and enhancing the efficiency of use of the processing apparatus 1.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A processing apparatus, comprising:
a processing quality prediction unit outputting at least a workpiece surface processing signal;
a storage unit storing at least a workpiece surface processing signal; and
a workpiece surface information management unit interpreting said workpiece surface processing signal, wherein said workpiece surface information management unit converts said surface processing signal into data of workpiece surface quality.

2. The processing apparatus, as recited in claim 1, wherein said processing quality prediction unit outputs signals selected from the group consisting of vibration, current and image, wherein said workpiece surface information management unit interprets said signal with artificial intelligence program.
